(19) United States
(12) Patent Application Publication
(10) Pub. No.: US 2025/0236187 A1
(43) Pub. Date: Jul. 24, 2025

(54) Charging Socket Unit for a Hybrid or Electric Vehicle

(71) Applicant: Bayerische Motoren Werke Aktiengesellschaft, Muenchen (DE)

(72) Inventors: Benedikt FELLA, Muenchen (DE); Jasmin TAHAN, Muenchen (DE)

(21) Appl. No.: 18/853,153

(22) PCT Filed: Jun. 22, 2023
(86) PCT No.: PCT/EP2023/066897

§ 371 Date: Oct. 1, 2024

(30) Foreign Application Priority Data
Jul. 11, 2022 (DE) 10 2022 117 232.5

(51) Int. Cl. B60L 53/16; B60L 50/60; B60Q 1/30; B60R 5/04; B60R 16/02

(52) U.S. Cl. CPC B60L 53/16; B60L 50/60; B60Q 1/30; B60R 5/04; B60R 16/0215

(57) ABSTRACT

A hybrid or electric vehicle, includes: a body which surrounds a vehicle interior region designed as a dry region; a lighting assembly which is attached to the body; a charging socket unit which can be at least partly integrated into the lighting assembly and/or is adjacent to this assembly, for connecting an external energy source; and an electrical energy store for providing energy for driving the hybrid or electric vehicle. The energy store is electrically connected to the charging socket unit via a charging line. The charging line extends completely or at least in portions in the vehicle interior region.

### BACKGROUND AND SUMMARY

The invention relates to a hybrid or electric motor vehicle comprising a lighting assembly and a charging socket unit, which can be at least partially integrated in the lighting assembly and/or is adjacent thereto, for connecting an external energy source.

Hybrid or electric motor vehicles have an electric energy storage device, for example a high-voltage storage device, in order to provide the electric energy necessary for the propulsion of the motor vehicle, and a charging socket unit, which is connected via cables or via a charging line to the energy storage device, so that the energy storage device can be charged by means of a charging plug via the charging socket unit.

Charging socket units are known from the prior art, which are arranged in a feedthrough of the body in the side frame of the hybrid or electric motor vehicle, in which typically the charging socket unit is arranged together with or instead of the tank filling pipe. The installation of a charging socket unit is made more difficult in this area due to package problems.

In order to also prevent penetration of moisture and/or liquids, these charging socket units are sealed both at the passage opening to the body outer skin and at the passage opening to the body inner skin. The installation thus takes place according to a wet-dry-wet concept on the body of the hybrid or electric motor vehicle.

However, this solution results in a large installation effort, since the charging socket unit has to be sealed off on two planes.

DE 10 2020 100 147 A1 describes a lighting assembly for an electric motor vehicle having a housing and a charging socket, wherein the housing delimits a first chamber and at least one further second chamber. Here, the first chamber represents a wet area and the charging socket is partially or completely arranged in the first chamber. The charging socket is connected by cables to a high-voltage storage device. The charging socket is at least partially arranged here inside the lighting assembly.

An electric vehicle is known from US 2013/0 076 059 A1, having a body, a body wall, which is part of the body and separates a vehicle interior area representing a dry area from a body exterior area representing a wet area, a passage opening in the body wall, which couples the vehicle interior area to the body exterior area, and a charging socket unit, which closes the passage opening and comprises a charging socket having a charging plug connection.

A hybrid or electric motor vehicle is known from post-published DE 10 2021 108 061 A1, having a body, a body wall, which is part of the body and separates a vehicle interior area representing a dry area from a body exterior area representing a wet area, a passage opening in the body wall, which couples the vehicle interior area to the body exterior area, a charging socket unit, which closes the passage opening and comprises a charging socket having a charging plug connection, and a bumper, which has an access opening and is attached to the body so that the access opening is aligned at least in some sections with the passage opening and the charging socket connection is accessible through the passage opening to plug in a charging plug.

The object of the invention is to provide a hybrid or electric motor vehicle which enables easy installation of the charging socket unit and enables a high performance of the charging socket unit.

To achieve the object, the invention provides a hybrid or electric vehicle, comprising a body, which surrounds a vehicle interior area designed as a dry area, a lighting assembly fastened to the body, a charging socket unit, which can be at least partially integrated into the lighting assembly and/or is adjacent thereto, for connecting an external energy source, and an electrical energy storage device for providing energy to drive the hybrid or electric vehicle, which is electrically connected via a charging line to the charging socket unit, wherein the charging line extends at least in some sections in the vehicle interior area.

The charging line preferably extends completely in the vehicle interior area, or it extends at least predominantly in the vehicle interior area.

The charging line preferably extends in the vehicle interior area at least in the area of a cable connection of the charging socket unit.

For example, the charging line extends in the vehicle interior area up to a passage opening of the body, at which the electrical energy storage device or a battery box containing it is arranged.

The charging line advantageously extends up to the electrical energy storage device or up to a battery box containing it in the vehicle interior area.

The charging line is preferably embodied as a flat band line.

A body wall is preferably provided, which is part of the body and separates the vehicle interior area from a body exterior area, which represents a wet area.

A passage opening, which couples the vehicle interior area to the vehicle exterior area, is preferably provided in the body wall, wherein the charging socket unit closes the passage opening.

The vehicle interior area or a part thereof is advantageously a baggage compartment of the vehicle.

The charging socket unit is preferably arranged in front of the lighting assembly in the longitudinal direction of the vehicle.

The charging socket unit advantageously has a charging socket mount, by which a charging socket is fastened on the body wall and/or on the taillight unit.

Improved performance can be achieved by arranging the charging line in the vehicle interior area, since the line cross section can be made larger.

Improved electromagnetic compatibility can also be achieved in that, for example, multiple lines or cables can extend lying one on top of another.

In particular, the advantages are also increased by using a flat band line as the charging line.

A preferred exemplary embodiment of the invention is explained in more detail hereinafter on the basis of drawings.

### BRIEF DESCRIPTION OF THE DRAWINGS

FIG. 1 is a side view of a hybrid or electric motor vehicle according to an embodiment of the invention having an integrated lighting assembly;

FIG. 2 is a rear view of the electric motor vehicle from FIG. 1; and

FIG. 3 is a sectional view of a body shell of the hybrid or electric motor vehicle according to FIG. 1.

In the figures, identical or mutually corresponding elements are each identified by the same reference signs and are therefore not described again if this does not appear expedient. The disclosures contained in the entire description are transferable accordingly to parts having identical reference signs or identical component names.

### DETAILED DESCRIPTION OF THE DRAWINGS

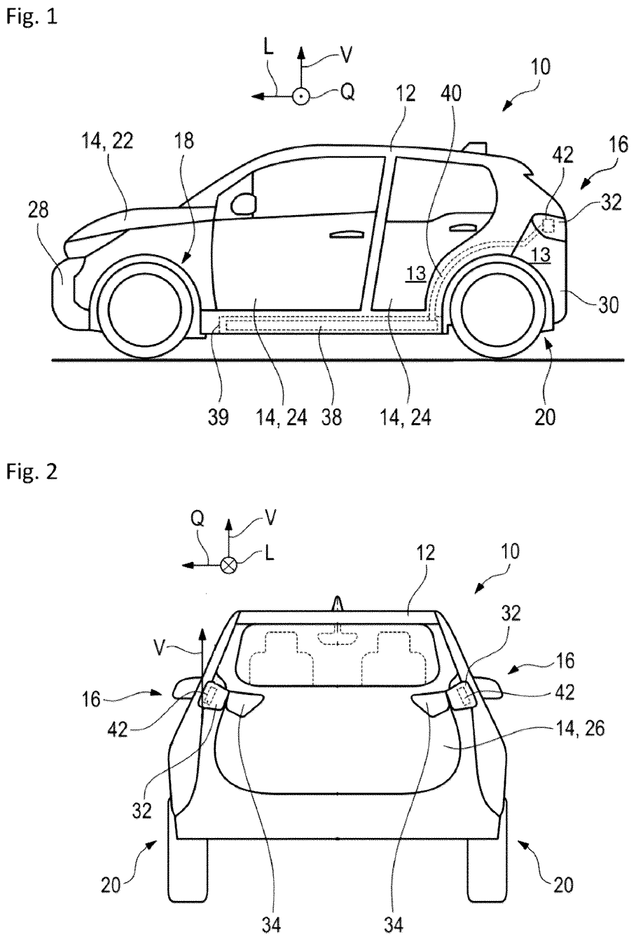

FIG. 1 and FIG. 2 show a side view and a rear view, respectively, of an electric motor vehicle 10.

The location and orientation of the components of the electric motor vehicle 10 are specified hereinafter with respect to their installation location on the electric motor vehicle 10. The coordinate system of the installation location is indicated in the figures for better comprehension. The coordinate system here has three axes, as shown in FIG. 1, namely the longitudinal direction L, the transverse direction Q, and the vertical V, which correspond to the longitudinal direction, the transverse direction, and the vertical direction of the electric motor vehicle 10.

The transverse direction Q in FIG. 1 points out of the plane of the drawing here and the longitudinal direction in FIG. 2 points into the plane of the drawing.

The electric motor vehicle 10 comprises a body 12, which delimits or surrounds a vehicle interior area 13, and a lighting assembly 32 fastened on the body 12 and designed in this example as a taillight assembly.

The vehicle interior area 13 forms a dry area delimited to the outside and protected against the penetration of moisture.

The body 12 is the supporting structure of the electric motor vehicle 10. Among other things, it has two front wheel arches 18 and two rear wheel arches 20.

A charging socket unit 42, which comprises a charging socket or is designed as a charging socket, is integrated in the lighting or taillight assembly 32. The charging socket or charging socket unit 42 is designed for the connection of an external energy source (not shown in the figure). In the example described here, the charging socket unit 42 is completely integrated or contained in the lighting or taillight assembly 32.

In other exemplary embodiments, the charging socket unit 42 is partially integrated or contained in the lighting or taillight assembly 32. It can also be arranged directly adjacent to the lighting or taillight assembly 32.

An electrical energy storage device in the form of a high-voltage storage device 38, which is used to provide energy to drive the hybrid or electric vehicle 10, is electrically connected via a charging line 40, which comprises one or more cables, to the charging socket unit 42. The charging line 40 extends in this case in the vehicle interior area 13, wherein it is in particular arranged completely in the vehicle interior area 13.

In other embodiments, the charging line 40 extends at least in some sections or predominantly in the vehicle interior area 13. The charging line 40 can also extend, for example, at least in the area of a cable connection of the charging socket or charging socket unit 42 in the vehicle interior area 13.

The charging line 40 is advantageously designed as a flat band line.

The high-voltage storage device 38 is mounted in a battery box 39, which can be formed inside or outside the vehicle interior area 13. In the example shown here, it is arranged in the vehicle interior area 13.

The high-voltage storage device 38 is, on the one hand, connected to an electric motor (not shown) of the electric motor vehicle 10 and, on the other hand, it is connected via the charging line or cable 40 to the charging socket or charging socket unit 42. The high-voltage storage device 38 can be charged using a corresponding charging plug via the charging socket 42 and the charging line 40.

In the example shown, the high-voltage storage device 38 is connected to two charging sockets 42 of the electric motor vehicle 10, which are arranged on opposing longitudinal sides of the electric motor vehicle 10 (see FIG. 2). In other embodiments, a charging socket 42 is only located on one side of the vehicle. One or more charging sockets 42 can also be arranged on one or both sides of the vehicle.

In cases in which the high-voltage storage device or energy storage device 38 is mounted in a battery box 39 arranged outside the vehicle interior area 13, the charging line 40 extends in the vehicle interior area 13 and then through a passage opening of the body wall into the battery box 39 adjacent thereto or to the electrical energy storage device 38 contained therein.

A front bumper 28 and a rear bumper 30 are fastened on the body 12. Furthermore, the body 12 comprises movably attached body add-on parts 14, in particular doors 24, motor hood 22, and taillights 16, which are arranged on the body 12 and which are formed by or comprise the lighting assembly 32.

As shown in FIG. 2, the taillights 16 each have the lighting assembly 32 and a lighting device 34 adjacent thereto. The lighting devices 34 are each arranged on the rear hatch 26 and are adjacent, in the closed state of the rear hatch 26, in the transverse direction Q, to the corresponding lighting assembly 32. They have a gap as the spacing.

In the embodiment of FIG. 2, the lighting assemblies 32 are each designed as a taillight assembly and extend both over a part of the rear side of the electric motor vehicle 10 (FIG. 2) and over a part of the long or lateral side of the electric motor vehicle 10 (FIG. 1).

The taillight assembly 32 having the charging socket or charging socket unit 42 integrated therein is extensively described with respect to further features and details in document DE 10 2020 100 147 A1 mentioned at the outset, to which reference is expressly made here.

The course of the charging line 40, which is arranged completely inside the vehicle interior area 13, is described hereinafter.

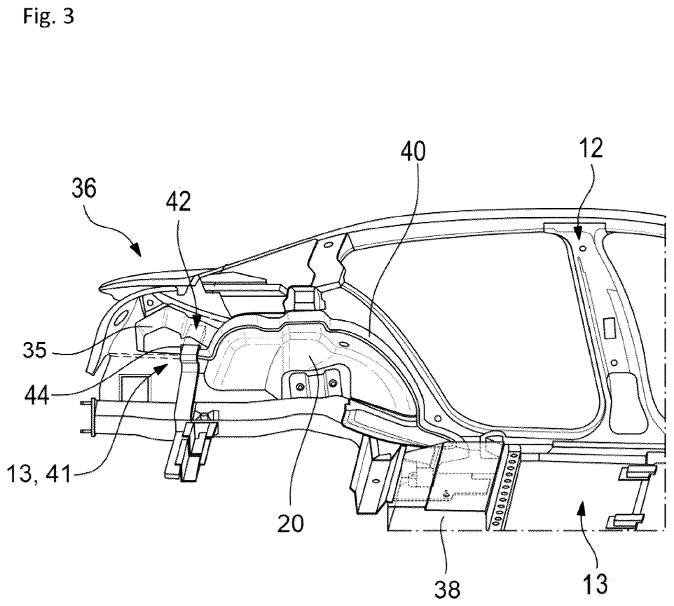

For this purpose, FIG. 3 shows a shell of the body 12 without the body add-on parts 14. The body 12 comprises the vehicle interior area 13, which is delimited by the body 12 and represents a dry area.

In the area of the charging socket unit 42, the body 12 has a body wall 35, which is part of the body 12 and is formed as an indentation. The charging socket unit 42 is arranged in this indentation. Since the charging socket unit 42 is concealed here by the body wall 35, the charging socket unit 42 is shown by dashed lines.

The body wall 35 separates the vehicle interior area 13 and therefore the dry area from a body exterior area 36, which is present outside the body 12 and represents a wet area.

In the embodiment shown here, the vehicle interior area 13 in the area of the charging socket unit 42 is a baggage compartment 41 of the motor vehicle 10.

The charging line 40 or the cables extend entirely in the vehicle interior area 13 and are accordingly arranged completely in the dry area. The charging line or cables 40 moreover largely extend in a particularly space-saving manner on an upper side of a wheel arch 20 of the motor vehicle 10.

In order to be able to connect the charging line 40 to the charging socket unit 42, a passage opening 44 is provided in the body wall 35, which passage opening is configured as a body breakthrough and connects the vehicle interior area 31, which is formed, for example, by the baggage compartment 41, to the body exterior area 36 and therefore connects the dry area to the wet area.

The charging socket or charging socket unit 42 is arranged in the passage opening 44 and seals off the passage opening 44 together with a correspondingly shaped seal, so that the vehicle interior area 13 and the body exterior area 36 are separated from one another in a liquid-tight manner.

The charging socket 42 extends here from the body exterior area 36 into the vehicle interior area 13. A charging plug connection of the charging socket 42 is arranged here in the wet area at least when the charging flap is open, and a cable connection of the charging socket 42, to which the charging line 40 or cable is connected, is arranged here in the dry area.

The charging line 40 therefore extends completely in the dry area, i.e., in the vehicle interior area 13 up to the point at which the electrical energy storage device 38 or the battery box 39 is arranged, which contains the energy storage device 38.

### LIST OF REFERENCE SIGNS

10 electric motor vehicle
12 body
13 vehicle interior area
14 body add-on parts
16 taillights
18 front wheel arches
20 rear wheel arches
22 motor hood
24 doors
28 front bumper
30 rear bumper
32 lighting assembly or taillight assembly
34 lighting device
35 body wall
36 body exterior area
38 electrical energy storage device/high-voltage storage device
39 battery box
40 charging line/cable
41 baggage compartment
42 charging socket/charging socket unit
44 passage opening
L longitudinal direction
Q transverse direction
V vertical

1.-8. (canceled)

9. A hybrid or electric vehicle, comprising:
a body which surrounds a vehicle interior area designed as a dry area;
a lighting assembly fastened on the body;
a charging socket unit, which is at least partially integrated in the lighting assembly and/or is adjacent thereto, for connecting an external energy source; and
an electric energy storage device that provides energy to drive the hybrid or electric vehicle, which electric energy storage device is electrically connected via a charging line to the charging socket unit,
wherein the charging line extends at least in some sections in the vehicle interior area designed as the dry area.

10. The hybrid or electric vehicle according to claim 9, wherein the charging line:
(i) extends completely in the vehicle interior area, or
(ii) extends predominantly in the vehicle interior area.

11. The hybrid or electric vehicle according to claim 9, wherein the charging line:
(i) extends in the vehicle interior area at least in an area of a cable connection of the charging socket unit, and/or
(ii) extends in the vehicle interior area up to a passage opening of the body, at which the electrical energy storage device or a battery box containing the storage device is arranged; and/or
(iii) extends in the vehicle interior area up to the electrical energy storage device or the battery box.

12. The hybrid or electric vehicle according to claim 9, wherein the charging line is a flat band line.

13. The hybrid or electric vehicle according to claim 9, wherein
a body wall, which is part of the body, separates the vehicle interior area from a body exterior area representing a wet area.

14. The hybrid or electric vehicle according to claim 13, wherein
a passage opening is provided in the body wall, which passage opening couples the vehicle interior area to the body exterior area, and
the charging socket unit closes the passage opening.

15. The hybrid or electric vehicle according to claim 9, wherein
the vehicle interior area is a baggage compartment of the vehicle.

16. The hybrid or electric vehicle according to claim 9, wherein
the charging socket unit is arranged in the lighting assembly or is arranged, in a longitudinal direction of the vehicle, in front of the lighting assembly.
